(19) United States
(12) Patent Application Publication
(10) Pub. No.: US 2009/0028751 A1
(43) Pub. Date: Jan. 29, 2009

(54) ANTI-MICROBIAL TIME CARD

(76) Inventor: Glenn Robbins, Raleigh, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 11/781,356

(22) Filed: Jul. 23, 2007

(51) Int. Cl. G01N 21/77; G01N 21/78; G06K 19/06

(52) U.S. Cl. 422/55; 235/494

(57) ABSTRACT

A time card including a card body having indicia on and/or in the card related to the time and attendance monitoring function of the card, wherein the time card includes an antimicrobial agent on and/or in the card body, wherein the antimicrobial agent is adapted to combat microbial pathogens. In a further embodiment, the time card includes an indicator, e.g., a calorimetric indicator, and undergoes a change indicative of having been contacted with a pathogen for which the indicator is effective.

### FIELD OF THE INVENTION

The present invention relates to time cards of a type used with time and attendance monitoring equipment such as time clocks and time recorders.

### DESCRIPTION OF THE RELATED ART

Time and attendance monitoring systems using time cards are ubiquitous in workplaces around the world. Such systems are utilized for monitoring employee arrivals to and departures from the workplace, recording of mealtime periods and breaks during the workday, and tracking of locations of employees in workplaces having multiple work areas.

Time and attendance monitoring systems are widely commercially available from a variety of sources, including Acroprint Time Recorder Company, Raleigh, N.C.; Amano USA, Inc. (Roseland, N.J.); and Latham Time (Atlanta, Ga.). One particularly widely commercialized timer clock is the Model 125 Time Clock of Acroprint Time Recorder Company.

### SUMMARY OF THE INVENTION

The present invention relates to time cards of a type used with time clocks and other time and attendance monitoring systems.

In one aspect, the invention relates to a time card including a card body having indicia on and/or in the card related to the time and attendance monitoring function of the card, wherein the time card includes an antimicrobial agent on and/or in the card body, wherein the antimicrobial agent is adapted to combat microbial pathogens.

In another aspect, the invention relates to a time card of such type, in which the antimicrobial agent comprises an antimicrobial coating that is applied to the card body on its outer surfaces.

In a further aspect, the invention relates to a time card of the above-described type, in which the antimicrobial agent is incorporated in the card body in a particulate time-release form.

A further aspect of the invention relates to a time card of the above-described type, which in addition to the antimicrobial agent includes a calorimetric indicator for any of a variety of pathogens, so that in addition to combating the pathogenic species, the card also changes color to indicate whether it has been contacted with such pathogens.

Other aspects, features and embodiments of the invention will be more fully apparent from the ensuing disclosure and appended claims.

### BRIEF DESCRIPTION OF THE DRAWINGS

FIG. 1 is a schematic representation of a time clock, with which the time cards of the invention can be used, according to one embodiment of the invention.

FIG. 2 is a schematic representation of an array of time cards, according to one embodiment of the invention.

### DETAILED DESCRIPTION OF THE INVENTION, AND PREFERRED EMBODIMENTS THEREOF

The present invention relates to time cards of a type used with time clocks and other time and attendance monitoring systems.

In one embodiment, the time card of the invention includes a card body having indicia on and/or in the card related to the time and attendance monitoring function of the card, with the time card including an antimicrobial agent on and/or in the card body, wherein the antimicrobial agent is adapted to combat microbial pathogens.

The antimicrobial agent may be incorporated in the time card in any suitable manner, and may for example include an antimicrobial coating that is applied to the card body on its outer surfaces, as applied by spraying, dipping, immersion in a coating bath, roller coating, lamination with an antimicrobial sheet on both main faces of the card, or in other suitable manner. Alternatively, the antimicrobial agent may be incorporated in the card stock during its manufacture, for example by incorporating the agent in a furnish including cellulosic fibers, water and the antimicrobial agent in particulate or solubilized form, for manufacture of the time card by a Fourdrinier or other wet-laid card-making process, so that the antimicrobial agent permeates the fibers as a solution component, or is incorporated as a solid, e.g., particulate or granular material, in the sheet-form product that is subsequently cut, trimmed, printed, etc. to form the time card. In one embodiment, the antimicrobial agent is incorporated on and/or in the time card in the card stock sizing during the manufacturing of the time card.

In a further embodiment, the antimicrobial agent is incorporated in the card body in a particulate time-release form, e.g., in a microencapsulated form in which the microcapsules are moisture-sensitive and degrade to release the antimicrobial agent under atmospheric humidity conditions.

The antimicrobial agent may be of any suitable type and may for example include The antimicrobial agent may include, without limitation, silver zeolites; antimicrobial siloxane quarternary ammonium salts; 3-(trimethoxysilyl) propyloctadecyldimethyl ammonium chloride; silver; silver ion source materials; antimicrobial oils such as oregano oil, tea tree oil, mint oil, sandalwood oil, clove oil, Nigella sativa, onion oil, leleshwa oil, lavender oil, lemon oil, lemon myrtle oil, eucalyptus oil, peppermint oil, cinnamon oil, thyme oil, etc.; doped zinc oxide nanomaterials, doped with copper, silver or aluminum; sodium nitrite; quaternary ammonium chloride; potassium nitrate; natamycin (pimaricin); heptylparaben; dehydroacetic acid; dimethyldicarbonate; benzoic acid; sodium benzoate; acetic acid; lactic acid; propionic acid; calcium proplonate; methylparaben; sodium bisulfite; sodium metabisulfite; sodium sorbate; sodium sulfite; sorbic acid; calcium sorbate; potassium bisulfite; potassium metabisulfite; potassium sorbate; propylparaben; sodium diacetate; sodium propionate; platensimycin; hydroxyphenyl-1,3-propanediones; etc.

The time card in another embodiment of the invention incorporates, in addition to the antimicrobial agent, a colorimetric indicator for one or more pathogens, so that in addition to combating the pathogenic species by antimicrobial action, the card also changes color to indicate whether it has been contacted with specific target pathogen(s). Such colorimetric indicator component may for example be incorporated in the card in a coating thereon, and/or as a component of the card body, or in any other suitable manner, analogous to the various manners of incorporation of the antimicrobial agent in the time card.

The colorimetric pathogen indicator may be of any suitable type, and may for example include colorimetric biosensor materials for detection of bacterial toxins, as described by Jie Song, et al. in “‘Smart’” Materials for Biosensing Devices: Cell-Mimicking Supramolecular Assemblies and Colorimetric Detection of Pathogenic Agents,” Biomedical Microdevices, Volume 4, Number 3, July 2002, pages 213-221, or polymerized multilayer coatings may be applied to the card for detection of receptor-ligand interactions to detect influenza virus, using polymerized multilayers as described in Charych, D. H.; Nagy, J. O.; Spevak, W.; Bednarski, M. D. Science, 261, (1993), pp. 585; Pan, J. J.; Charych, D. Langmuir, 13, (1997), pp. 1365, or any other color-change reporter components can be employed for the detection of pathogens, e.g., communicable disease-producing agents, deleterious bacteria, viruses, fungi, etc.

Alternatively, the time card may include a pathogen indicator that allows detection by a specific instrument or detector system, e.g., a fluorescent pathogen indicator that by placement of the time card under a fluorescent light scanner can detect by the resulting fluorescence whether a person handling the card has by such handling transferred a pathogen to the card, or other pathogen indicator component or material that in interaction with radiation of a specific wavelength produces an output indicative of the presence or absence of a target pathogen.

By such pathogen detection character, the time card can be additionally monitored to determine whether workers or other handlers of the card are carrying a communicable virus or bacterial agent, so that a positive determination by the calorimetric or other indication using the card can be used to identify individuals who should be directed to medical attention and treatment for colds, influenza, cholera, diphtheria, etc.

This capability is particularly advantageous in workplaces such as factories, in which viral or bacterial infection can be transmitted through a labor force group quite rapidly by sequential handling of parts and components, blueprints, assembly drawings, work orders, and machines, as well as in other workplaces where the risk of transmission of viral or bacterial vectors is significant. By identifying and isolating a specific person or group of persons at an early stage of detection, the chances of propagation of the disease-causing agent can be minimized, to maintain a healthy workforce.

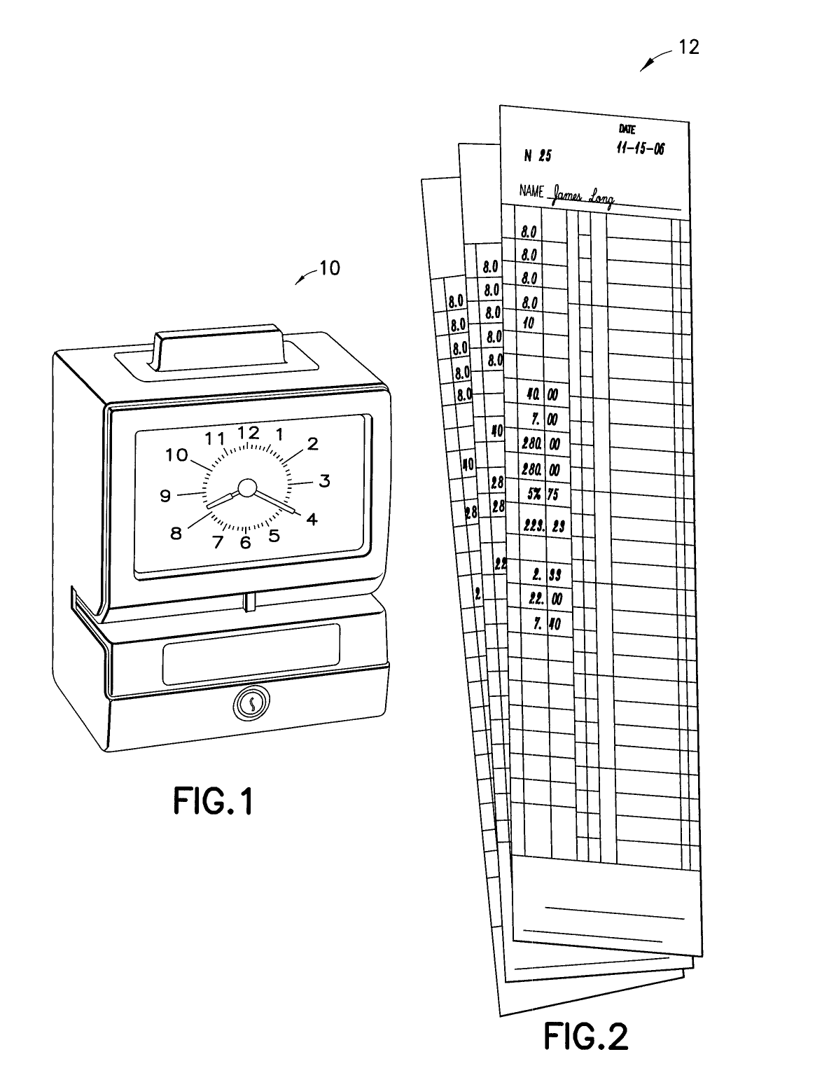

FIG. 1 is a graphic representation of a time clock 10, with which the time cards of the invention can be used, and FIG. 2 is a graphic representation of an array of time card, according to one embodiment of the invention, which includes an antimicrobial agent and optionally a detection capability for pathogens.

The time cards of the invention can be fabricated of any suitable material of construction, including sheet-form or web articles formed of cellulosic or other natural or synthetic materials, e.g., of materials of a fibrous or non-fibrous character, or of other suitable form and/or material construction.

The time card typically has printed or embossed or otherwise set out thereon indicia related to the time card monitoring function of the card, and such indicia may be in bar-coded, magnetic strip or other carrier form. Such indicia may for example include date and time fields, overtime fields, employee numbers and number fields, company name, employee name, and the like.

It will be recognized that the time card of the invention may be constituted and configured in any of a variety of manners, consistent with the broad disclosure herein, as adapted for a specific monitoring function and/or system.

Accordingly, while the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A time card including a card body having indicia on and/or in the card related to the time and attendance monitoring function of the card, wherein the time card includes an antimicrobial agent on and/or in the card body, wherein the antimicrobial agent is adapted to combat microbial pathogens.

2. A time card according to claim 1, in which the antimicrobial agent comprises an antimicrobial coating that is applied to the card body on its outer surfaces.

3. A time card according to claim 1, in which the antimicrobial agent is incorporated in the card body in a particulate time-release form.

4. A time card according to claim 1, further comprising a indicator for one or more microbial pathogens, whereby the card in contact with said one or more microbial pathogens undergoes a change that is indicative of presence of said one or more microbial pathogens on the card.

5. A time card according to claim 4, wherein the indicator includes a calorimetric indicator.

6. A time card according to claim 4, wherein the indicator comprises a fluorescing indicator agent.

7. A time card according to claim 1, wherein the antimicrobial agent comprises an agent selected from among: silver zeolites; antimicrobial siloxane quarternary ammonium salts; 3-(trimethoxysilyl) propyloctadecyldimethyl ammonium chloride; silver; silver ion source materials; antimicrobial oils; oregano oil, tea tree oil, mint oil, sandalwood oil, clove oil, Nigella sativa, onion oil, leleshwa oil, lavender oil, lemon oil, lemon myrtle oil, eucalyptus oil, peppermint oil, cinnamon oil, thyme oil, etc.; doped zinc oxide nanomaterials, doped with copper, silver or aluminum; sodium nitrite; quaternary ammonium chloride; potassium nitrate; natamycin (pimaricin); heptylparaben; dehydroacetic acid; dimethyldicarbonate; benzoic acid; sodium benzoate; acetic acid; lactic acid; propionic acid; calcium proplonate; methylparaben; sodium bisulfite; sodium metabisulfite; sodium sorbate; sodium sulfite; sorbic acid; calcium sorbate; potassium bisulfite; potassium metabisulfite; potassium sorbate; propylparaben; sodium diacetate; sodium propionate; platensimycin; hydroxyphenyl-1,3-propanediones; and mixtures including one or more of the foregoing agents.

8. A time card according to claim 1, wherein the antimicrobial agent is incorporated in the card body in a particulate time-release form.
